(19) United States
(12) Patent Application Publication
(10) Pub. No.: US 2025/0216094 A1
(43) Pub. Date: Jul. 3, 2025

(54) CLIP MEMBER AND INSTALLATION STRUCTURE INCLUDING SAME

(71) Applicant: SAMSUNG ELECTRONICS CO., LTD., Suwon-si (KR)

(72) Inventors: Jinwoo HONG, Suwon-si (KR); Donghyun KIM, Suwon-si (KR); Sungwoo KIM, Suwon-si (KR); Joonho YOON, Suwon-si (KR); Buyoun LEE, Suwon-si (KR); Mingu JEON, Suwon-si (KR)

(73) Assignee: SAMSUNG ELECTRONICS CO., LTD., Suwon-si (KR)

(21) Appl. No.: 19/085,792

(22) Filed: Mar. 20, 2025

Related U.S. Application Data
(63) Continuation of application No. PCT/KR2023/013623, filed on Sep. 12, 2023.

(30) Foreign Application Priority Data
Dec. 7, 2022 (KR) 10-2022-0169443

(51) Int. Cl. F24F 1/0047; F16M 13/02

(52) U.S. Cl. CPC F24F 1/0047; F16M 13/027; F24F 2221/14

(57) ABSTRACT

An installation structure for a ceiling-mounted indoor unit includes: a supporting member including an end portion fixed to a ceiling wall and configured to pass through a hanger bar connected to the indoor unit; and a clip member including: a body including a penetration portion in which the supporting member is configured to pass through, an extension extending along a length of the supporting member from the body, and an engaging portion extending from an end portion of the extension and configured to be locked to the hanger bar.

### CROSS-REFERENCE TO RELATED APPLICATION(S)

This application is a continuation of International Application No. PCT/KR2023/013623, filed on Sep. 12, 2023, in the Korean Intellectual Property Receiving Office, which is based on and claims priority to Korean Patent Application No. 10-2022-0169443, filed on Dec. 7, 2022, in the Korean Intellectual Property Office, the disclosures of which are incorporated by reference herein in their entireties.

### BACKGROUND

### 1. Field

This disclosure relates to a clip member for installing an indoor unit of an air conditioner and an installation structure including the same.

### 2. Description of Related Art

An air conditioner is a device that performs a series of cycles and may include a compressor, a condenser, an expansion valve, and an evaporator in a cooling/heating system that may cool a room by repeatedly sucking in hot air from the room, exchanging heat with a low-temperature refrigerant, and then discharging it into the room, or may heat the room by the opposite action. An air conditioner may include indoor and outdoor units. The indoor unit may be installed mainly inside a building, and the outdoor unit may be installed outside the building.

One type of indoor unit may be fixed to a ceiling. A ceiling-fixed indoor unit may be installed by fixing the indoor unit in the inner space of the ceiling above the ceiling surface by full-threaded bolts fixed to the ceiling wall above the ceiling surface and one or more nuts fastened to the full-threaded bolts. When installing the indoor unit on the ceiling in such a manner, a sufficient working space may be required to fasten the full-treaded bolts and the nuts and to adjust the fastening height. However, it is not easy to secure a sufficient working space in the narrow space inside the ceiling, and the space limitation makes it more difficult to install the indoor unit.

### SUMMARY

Provided are a clip member and instillation structure including the same that may minimize the working space required to install a ceiling-mounted indoor unit.

Additional aspects will be set forth in part in the description which follows and, in part, will be apparent from the description, or may be learned by practice of the presented embodiments.

According to an aspect of the disclosure, an installation structure for a ceiling-mounted indoor unit may include: a supporting member including an end portion fixed to a ceiling wall and configured to pass through a hanger bar connected to the indoor unit; and a clip member including: a body including a penetration portion in which the supporting member is configured to pass through, an extension extending along a length of the supporting member from the body, and an engaging portion extending from an end portion of the extension and configured to be locked to the hanger bar.

The clip member may be configured to be rotated about the supporting member to be selectively locked to and unlocked from the hanger bar.

The body may further include a protrusion protruding from the penetration portion horizontally outward.

The extension may extend from an edge of the protrusion along an outside of a side surface that connects a lower surface and an upper surface of the hanger bar.

The protrusion may include an opening.

The protrusion may include a first protrusion and a second protrusion protruding symmetrically from opposite sides of the penetration portion, where the extension includes a first extension extending from an edge of the first protrusion in a direction perpendicular to the first protrusion, and a second extension extending from an edge of the second protrusion in a direction perpendicular to the second protrusion, and where the engaging portion includes a first engaging portion extending in a direction perpendicular to the first extension, and a second engaging portion extending in a direction perpendicular to the second extension.

The first engaging portion may extend from an end portion of the first extension in a first direction, and the second engaging portion may extend from an end portion of the second extension in a second direction that is parallel to and opposite of the first direction along a rotation direction.

The body may be configured to support a lower surface of the hanger bar, where the engaging portion extends along a plane parallel to an upper surface of the hanger bar and is configured to engage with the upper surface of the hanger bar.

The installation structure may further include: a first fastening member fastened to a lower side of the hanger bar and configured to support the hanger bar; and a second fastening member fastened to a lower side of the clip member and configured to support the clip member, where the body of the clip member is between the first fastening member and the second fastening member, and where the body further includes an accommodation space configured to accommodate at least a portion of the first fastening member.

According to an aspect of the disclosure, a clip member for fixing a hanger bar supporting a ceiling-mounted indoor unit may include: a body including a penetration portion having a through hole; an extension extending from the body in a direction perpendicular to the body; and an engaging portion extending from an end portion of the extension and configured to lock to the hanger bar.

The engaging portion may extend in a direction perpendicular to the extension.

The body may be configured to support a lower portion of the hanger bar, and the engaging portion may be configured to engage with an upper surface of the hanger bar.

The engaging portion may be configured to be selectively locked to and unlocked from the hanger bar by rotation about the through hole.

A lower edge of the engaging portion may be inclined or rounded.

The extension may include a first extension, and a second extension symmetrical to the first extension with respect to the through hole, where the engaging portion includes a first engaging portion extending in a direction perpendicular to the first extension, and a second engaging portion extending in a direction perpendicular to the second extension, and where the first engaging portion and the second engaging portion extend from respective end portions of the first extension and the second extension along a rotation direction.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a state of an indoor unit of an air conditioner installed on a ceiling by an installation structure, as viewed from above according to an embodiment;

FIG. 2 is a perspective view illustrating an installation structure according to an embodiment;

FIG. 3 is a side view illustrating an installation structure according to an embodiment;

FIG. 4 is an exploded perspective view illustrating an installation structure according to an embodiment;

FIG. 5 is a view illustrating a state of a clip member of an installation structure as viewed at various angles according to an embodiment;

FIG. 6A, FIG. 6B, and FIG. 6C are views illustrating an assembly process of an installation structure according to one or more embodiments;

FIG. 7 is a perspective view illustrating a clip member according to an embodiment;

FIG. 8A and FIG. 8B are views illustrating an assembly process of an installation structure including the clip member of FIG. 7 according to one or more embodiments;

FIG. 9 is a view illustrating a working space required to install an indoor unit of an air conditioner using a related art installation structure; and

FIG. 10 is a view illustrating a working space required to install an indoor unit on a ceiling using an installation structure according to an embodiment.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, description of well-known functions and configurations in the drawings and relevant descriptions may be omitted.

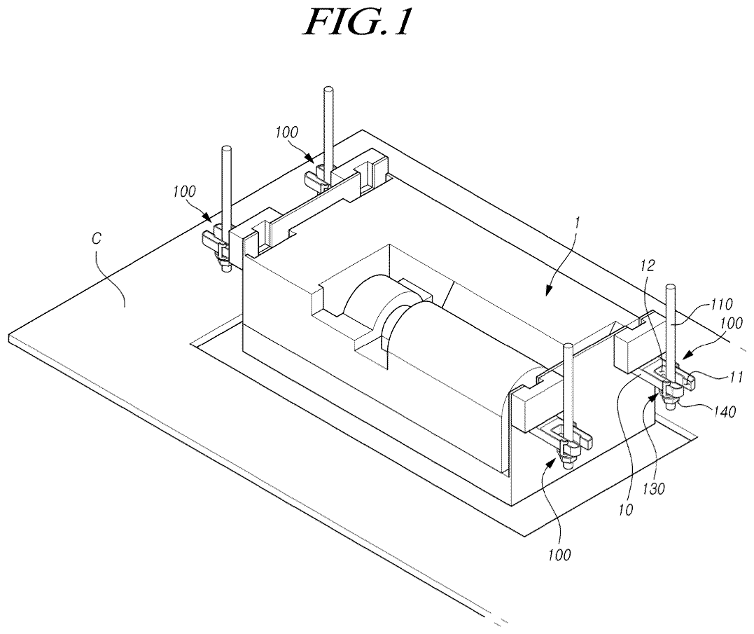

FIG. 1 is a view illustrating a state of an indoor unit of an air conditioner installed on a ceiling by an installation structure, as viewed from above according to an embodiment.

Referring to FIG. 1, the indoor unit 1 of the air conditioner may be installed at the upper ceiling wall above the ceiling surface C inside the building. For example, the installation structure 100 may be provided at each coupling position provided in four places around the indoor unit 1 to fix and support the indoor unit 1. Here, one installation structure 100 may be installed at each coupling position.

At each coupling position of the indoor unit 1, e.g., a hanger bar 10 connected to the main body 2 of the indoor unit 1 may be provided. The hanger bar 10 at each coupling position may be coupled to the installation structure 100. Here, the hanger bar 10 may be integrally formed with the main body 2 of the indoor unit 1, but is not limited thereto, but a separate hanger bar 10 may be assembled to the indoor unit 1.

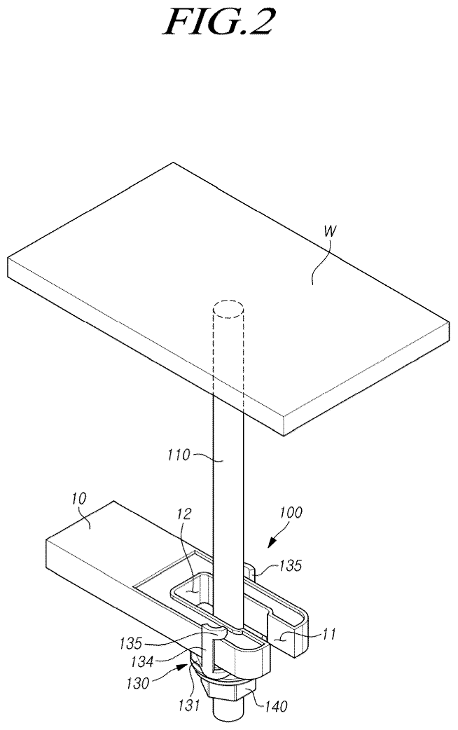

According to an example, each hanger bar 10 may have an upper surface and a lower surface that may be disposed parallel to the ground, and may have an opening (e.g., the opening 12 of FIG. 2) through which the supporting member 110 may pass through the upper surface and the lower surface, but the disclosure is not limited thereto. According to an example, each hanger bar 10 may have one side surface connected to the indoor unit 1 and the opposite side surface with an insertion hole (the insertion hole 11 of FIG. 2) enabling access to the inside of the above-described opening 12 from the outside, but the disclosure is not limited thereto. According to an example, each hanger bar 10 may have two other opposite side surfaces connecting the upper surface and the lower surface.

The indoor unit 1 may be installed to be positioned in the inner space of the ceiling between the ceiling surface C and the ceiling wall thereabove. When the indoor unit 1 is installed on the ceiling, a portion of the ceiling surface C may be removed to secure a horizontal area of the indoor unit 1 and a working space for installing the indoor unit 1.

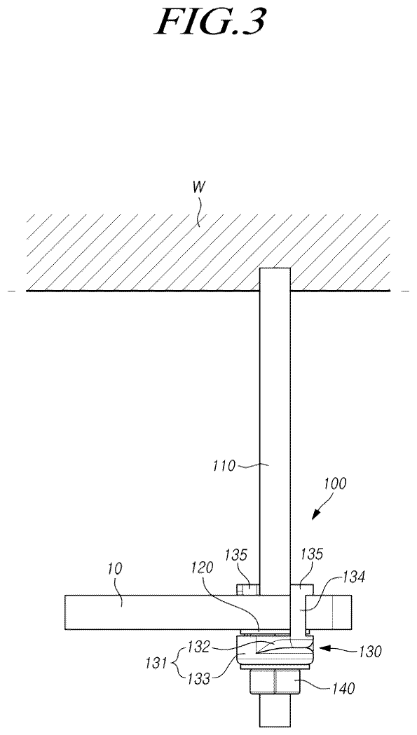

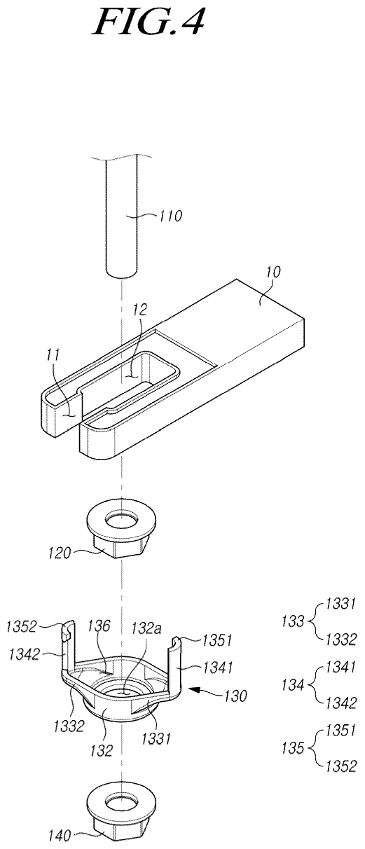

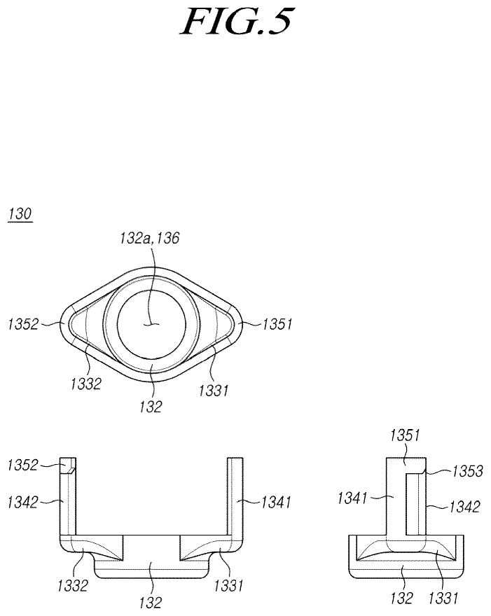

FIG. 2 is a perspective view illustrating an installation structure according to an embodiment. FIG. 3 is a side view illustrating an installation structure according to an embodiment. FIG. 4 is an exploded perspective view illustrating an installation structure according to an embodiment. FIG. 5 is a view illustrating a state of a clip member of an installation structure as viewed at various angles according to an embodiment.

Referring to FIGS. 2 to 5, an installation structure 100 may include a supporting member 110, a first fastening member 120, a clip member 130, and a second fastening member 140.

According to an example, the supporting member 110 may be disposed so that one end portion of the supporting member 110 is fixed to the upper ceiling wall and extends in a vertical downward direction. The supporting member 110 fixed to the ceiling wall may be disposed to penetrate each hanger bar 10 connected to the indoor unit (e.g., the indoor unit 1 of FIG. 1). According to an example, as illustrated, the supporting member 110 may be disposed to penetrate the opening 12 of the hanger bar 10. According to an example, as illustrated, the supporting member 110 may be inserted into the opening 12 through an insertion hole 11 provided in one side of the hanger bar 10. A thread may be formed on an outer circumferential surface of the supporting member 110. The supporting member 110 may be a full-threaded bolt, but is not limited thereto.

According to an embodiment, the first fastening member 120 may be fastened to the supporting member 110. According to an example, the first fastening member 120 may include a through hole, and the supporting member 110 may be inserted into the through hole so that both may be fastened to each other. In an example, the first fastening member 120 may be positioned under the hanger bar 10 in a state in which the supporting member 110 passes through the opening 12 of the hanger bar 10. The first fastening member 120 may move up and down in a state of being fastened to the supporting member 110. For example, the first fastening member 120 may move up and down in the length direction of the supporting member 110 in a state of supporting the lower surface of the hanger bar 10. For example, the first fastening member 120 may have a thread corresponding to the thread of the supporting member 110 inside the through hole, and may be rotated along the thread of the supporting member 110 to move up and down. The first fastening member 120 may be a nut or a washer integrated nut, but is not limited thereto.

According to an embodiment, the clip member 130 may include a body 131. The body 131 may include a penetration portion 132 configured to allow the supporting member 110 to pass therethrough. The supporting member 110 may pass through the through hole 132a formed in the penetration portion 132. The clip member 130 may be coupled to the supporting member 110 as the supporting member 110 is inserted into the through hole 132a of the body 131. The clip member 130 may be vertically moved in the length direction of the supporting member 110 in a state in which the supporting member 110 passes through the through hole 132a.

According to an embodiment, the body 131 may include a protrusion 133 protruding outward from the penetration portion 132. The protrusion 133 may protrude from two opposite sides of the penetration portion 132 in a direction perpendicular to the direction in which the supporting member 110 extends (e.g., in a horizontal direction parallel to the ground). The protrusion 133 may be a portion held by an operator to rotate the clip member 130. The protrusion 133 may be formed so that a portion thereof appears as protruding from the hanger bar 10 in the horizontal direction when viewed from an upper portion in the axial direction of the supporting member 110.

According to an example, the protrusion 133 may include a first protrusion 1331 and a second protrusion 1332 extending from two opposite sides in the horizontal direction of the penetration portion 132. The first protrusion 1331 and the second protrusion 1332 may be disposed to be symmetrical to each other on two opposite sides of the penetration portion 132.

According to an embodiment, the clip member 130 may include an extension 134 extending from the outside of the body 131. The extension 134 may extend in the length direction of the supporting member 110 from the body 131. The extension 134 may extend in a direction substantially perpendicular to the body 131. The extension 134 may extend from an edge of the body 131. For example, the extension 134 may extend from an edge of the protrusion 133 farthest from the penetration portion 132. The extension 134 may extend from a portion of the protrusion 133 that appears to protrude from the hanger bar 10 when viewed from an upper portion of the supporting member 110 in the axial direction. The extension 134 may extend from a portion of the protrusion 133 that does not overlap the hanger bar 10 when viewed from an upper portion of the supporting member 110 in the axial direction.

According to an embodiment, the extension 134 may include a first extension 1341 extending from an edge of the first protrusion 1331. The first extension 1341 may extend from the edge of the first protrusion 1331 farthest from the penetration portion 132. The first extension 1341 may extend in a direction perpendicular to the first protrusion 1331, for example. The first extension 1341 may extend along the axis of the supporting member 110 or inclined at a predetermined angle from the axis of the supporting member 110.

According to an embodiment, the extension 134 may include a second extension 1342 extending from an edge of the second protrusion 1332. The first extension 1341 may extend from the edge of the first protrusion 1331 farthest from the penetration portion 132. The second extension 1342 may extend in a direction perpendicular to the second protrusion 1332, for example. The second extension 1342 may extend along the axis of the supporting member 110, or inclined at a predetermined angle from the axis of the supporting member 110.

For example, the first extension 1341 and the second extension 1342 may extend substantially parallel to each other, but are not limited thereto. The extension 134 may tightly contact the side surface of the hanger bar 10 in a locked state to be described below. As the extension 134 tightly contacts the side surface of the hanger bar 10, the lateral movement of the hanger bar 10 generated by vibration or the like may be fixed.

According to an embodiment, the clip member 130 may include an engaging portion 135 extending from an end portion of each extension 134. The engaging portion 135 may be selectively locked to the upper surface of the hanger bar 10 according to the rotation of the clip member 130. The engaging portion 135 may extend in a direction perpendicular to the extending direction of the extension 134, e.g., in a direction parallel to the upper surface of the hanger bar 10.

According to an example, the engaging portion 135 may be formed to overlap the body 131 when the clip member 130 is viewed from the top. For example, the engaging portion 135 may have a shape corresponding to the shape of the edge of the body 131 when the clip member 130 is viewed from the top.

According to an embodiment, the engaging portion 135 may include a first engaging portion 1351 extending from the first extension 1341 in a first direction. According to an embodiment, the engaging portion 135 may include a second engaging portion 1352 extending from the second extension 1342 in a second direction. The first direction and the second direction may extend along the first rotation direction, for example. At least one of the first engaging portion 1351 and the second engaging portion 1352 may have a curved cross section.

Here, the first rotation direction may refer to a direction in which the clip member 130 rotates about the supporting member 110. For example, when the clip member 130 is rotated in the first rotation direction, the clip member 130 may be locked to the hanger bar 10. A state in which the clip member 130 is locked to the hanger bar 10 to fix the movement of the hanger bar 10 is referred to as a locked state. For example, when the clip member 130 is rotated in the second rotation direction opposite to the first rotation direction, the clip member 130 may be in an unlocked state. A state in which the clip member 130 is not locked to the hanger bar 10 is referred to as an unlocked state.

According to an example, the lower edge of the engaging portion 135 may be inclined or rounded. For example, the engaging portion 135 may include a chamfered portion 1353 where the free-end lower edge is inclined or rounded. When the clip member 130 is switched from the unlocked state to the locked state, the lower edge of the engaging portion 135 may be inclined or rounded so that the engaging portion 135 is easily locked to the upper surface of the hanger bar 10.

According to an example, the clip member 130 may be configured to be selectively locked to or unlocked from the hanger bar 10 by rotating about the supporting member 110 as an axis. For example, the body 131 of the clip member 130 supports one surface (e.g., the lower surface) of the hanger bar 10, and the engaging portion 135 of the clip member 130 is tightly locked to the other surface (e.g., the upper surface) of the hanger bar 10, thereby fixing the movement of the hanger bar 10. For example, the body 131 of the clip member 130 may support a lower portion of the hanger bar 10. For example, the engaging portion 135 of the clip member 130 tightly contacts the upper portion of the hanger bar 10 to prevent the hanger bar 10 from ascending due to vibration. The clip member 130 may be fixed so as not to be separated from the hanger bar 10 in the locked state. The clip member 130 may be coupled to or separated from the hanger bar 10 in the unlocked state.

The clip member 130 may fix the movement of the hanger bar 10 from the lower side of the first fastening member 120. When vibration occurs in the hanger bar 10 due to the operation of the indoor unit 1, the hanger bar 10 may be moved from the upper side of the first fastening member 120 so that the height of the indoor unit 1 may be changed or the leveling may be distorted. The clip member 130 may be disposed to stop the upward movement of the first fastening member 120 and the hanger bar 10 thereabove, and to fix the height of the hanger bar 10 and the indoor unit 1 connected thereto. The clip member 130 may be formed of a material having high rigidity. The clip member 130 may be formed of steel or stainless steel, but is not limited thereto.

According to an example, the clip member 130 may include an accommodation space 136 defined to accommodate at least portion of the first fastening member 120. For example, the body 131 may include an accommodation space 136 defined to accommodate at least portion of the first fastening member 120. If the clip member 130 is assembled to the lower side of the first fastening member 120, the clip member 130 may fix not only the hanger bar 10 but also the movement of the first fastening member 120 in the locked state.

According to an example, the second fastening member 140 may be fastened to the supporting member 110 from a lower side of the clip member 130. The second fastening member 140 may include a through hole, and the supporting member 110 may be inserted into the through hole so that both may be fastened to each other. In an example, the second fastening member 140 may support the clip member 130. For example, when the second fastening member 140 is tightened from the lower side of the clip member 130, the clip member 130 may tightly contact at least one of the first fastening member 120 or the hanger bar 10. In this case, the body 131 of the clip member 130 may be positioned between the first fastening member 120 and the second fastening member 140. As the clip member 130 is tightly fixed by the second fastening member 140, the clip member 130 may be prevented from being rotated and unlocked by vibration or the like. The second fastening member 140 may be a nut or a washer integrated nut, but is not limited thereto.

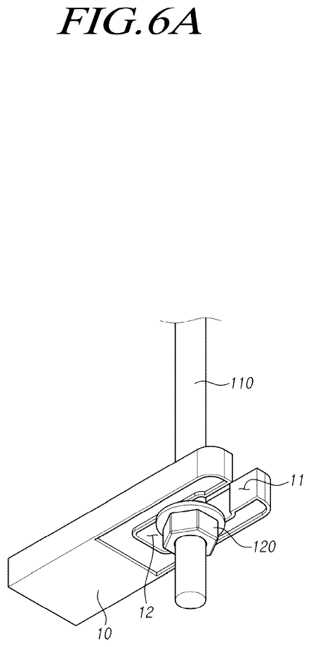

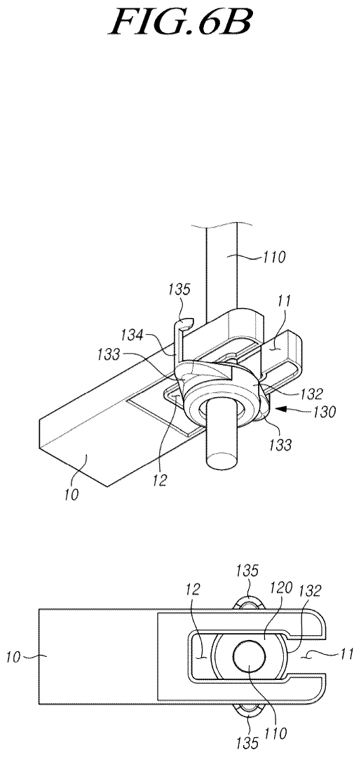

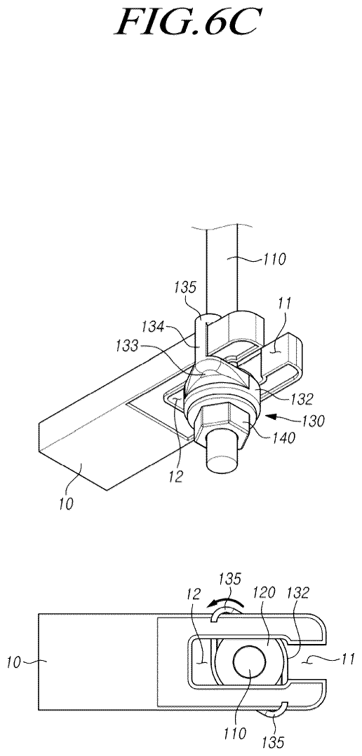

FIGS. 6A to 6C are views illustrating an assembly process of an installation structure according to one or more embodiments.

The components shown in the assembly process of FIGS. 6A to 6C may be substantially identical to the components of the installation structure 100 described in FIGS. 1 to 5.

Referring to FIG. 6A, the first fastening member 120 may be fastened in the downward direction with the supporting member 110 inserted into the insertion hole 11 of the hanger bar 10. The first fastening member 120 may be positioned under the hanger bar 10 to support the hanger bar 10. The operator may adjust the height of the indoor unit (e.g., the indoor unit 1 of FIG. 1) connected to the hanger bar 10 by adjusting the height of the first fastening member 120.

Referring to FIG. 6B, the clip member 130 may be coupled to the supporting member 110 from a lower end portion of the supporting member 110. The supporting member 110 may be inserted into the through hole 132a of the body 131 so that the body 131 of the clip member 130 is positioned under the first fastening member 120. After the operator completes the height adjustment of the indoor unit 1 using the first fastening member 120, the supporting member 110 may be inserted into the clip member 130. The clip member 130 may be inserted until the engaging portion 135 is positioned close to the upper surface of the hanger bar 10. In this case, the clip member 130 may be inserted in the unlocked state. In the unlocked state, the clip member 130 may be assembled to the hanger bar 10 or separated from the hanger bar 10.

Referring to FIG. 6C, in a state in which the engaging portion 135 of the clip member 130 is positioned close to the upper surface of the hanger bar 10, the clip member 130 may be rotated in the first rotation direction to be switched into the locked state. The clip member 130 may fix the vertical movement of the hanger bar 10 as the engaging portion 135 is locked to the upper surface of the hanger bar 10.

After rotating the clip member 130 to be in the locked state, the second fastening member 140 may be coupled to the supporting member 110 from the lower end portion of the supporting member 110. The supporting member 110 may be inserted into the second fastening member 140 so that the second fastening member 140 is positioned under the body 131 of the clip member 130. The second fastening member 140 may fix the clip member 130 so as not to rotate by tightening the lower portion of the clip member 130. The second fastening member 140 may prevent the clip member 130 from being rotated and unlocked due to vibration generated as the indoor unit 1 operates, or as the use period is prolonged.

As described in FIGS. 6A to 6C, the first fastening member 120, the clip member 130, and the second fastening member 140 may be positioned under the hanger bar 10 to be coupled to the supporting member 110. In an embodiment of the disclosure, the ceiling-mounted indoor unit 1 may be installed more conveniently by operating and assembling the first fastening member 120, the clip member 130, and the second fastening member 140 only on the lower side without using an additional fastening member on the upper side of the hanger bar 10.

As illustrated in FIG. 6C according to an embodiment, when readjustment of the height of the installation structure 100 is required after the installation of the indoor unit 1 is completed, the second fastening member 140 and the clip member 130 should be sequentially separated. The clip member 130 may be easily separated by being rotated in the second rotation direction opposite to the first rotation direction. In other words, the installation structure 100 of the disclosure may have a structure that is conveniently assembled or separated by easily switching between the locked state and the unlocked state by rotating the clip member 130.

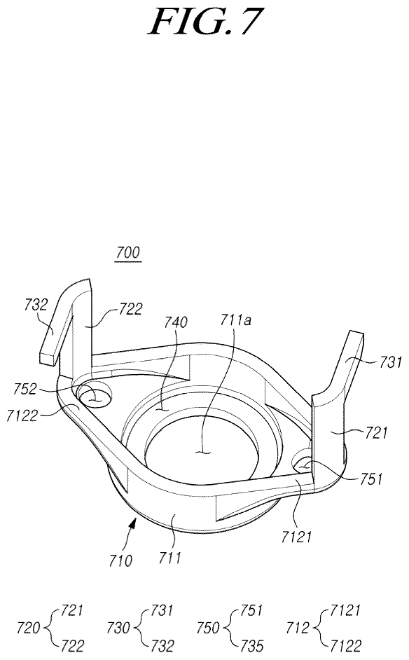

FIG. 7 is a perspective view illustrating a clip member according to an embodiment.

The clip member 700 shown in FIG. 7 may form one component of the installation structure (e.g., the installation structure 100 of FIG. 1) instead of the clip member 130 described in FIGS. 1 to 6C.

According to an embodiment, the clip member 700 may include a body 710. The body 710 may include a penetration portion 711 configured to allow the supporting member 110 to pass therethrough. The supporting member 110 may pass through the through hole 711a formed in the penetration portion 711. The clip member 700 may be coupled to the supporting member 110 as the supporting member 110 is inserted into the through hole 711a of the body 710.

According to an embodiment, the body 710 may include a protrusion 712 protruding outward from the penetration portion 711. The protrusion 712 may protrude in a direction perpendicular to the direction in which the supporting member 110 extends, for example. The protrusion 712 may be a portion held by an operator to rotate the clip member 700. The protrusion 712 may be formed so that a portion thereof appears as protruding from the hanger bar 10 when viewed from an upper portion in the axial direction of the supporting member 110.

According to an example, the protrusion 712 may include a first protrusion 7121 and a second protrusion 7122 extending with respect to the penetration portion 711. The first protrusion 7121 and the second protrusion 7122 may be disposed to be symmetrical to each other on two opposite sides of the penetration portion 711.

According to an embodiment, the protrusion 712 may include an opening 750. For example, the first protrusion 7121 and the second protrusion 7122 may include a first opening 751 and a second opening 752, respectively. The operator may rotate the clip member 700 using the first opening 751 and the second opening 752. Instead of rotating the clip member 700 by hand, the operator may rotate the clip member 700 by inserting a tool into at least one of the first opening 751 or the second opening 752 and then rotating the tool.

According to an embodiment, the clip member 700 may include an extension 720 extending from the outside of the body 710. The extension 720 may extend in the length direction of the supporting member 110 from the body 710. The extension 720 may extend in a direction substantially perpendicular to the body 710. The extension 720 may extend from an edge of the body 710. For example, the extension 720 may extend from an edge of the protrusion 712 farthest from the penetration portion 711. The extension 720 may extend from a portion of the protrusion 712 that appears to protrude from the hanger bar 10 when viewed from an upper portion of the supporting member 110 in the axial direction. The extension 720 may extend from a portion of the protrusion 712 that does not overlap the hanger bar 10 when viewed from an upper portion of the supporting member 110 in the axial direction.

According to an embodiment, the extension 720 may include a first extension 721 extending from an edge of the first protrusion 7121. The first extension 721 may extend from the edge of the first protrusion 7121 farthest from the penetration portion 711. The first extension 721 may extend in a direction perpendicular to the first protrusion 7121, for example. The first extension 721 may extend along the axis of the supporting member 110 or inclined at a predetermined angle from the axis of the supporting member 110.

According to an embodiment, the extension 720 may include a second extension 722 extending from an edge of the second protrusion 7122. The first extension 721 may extend from the edge of the first protrusion 7121 farthest from the penetration portion 711. The second extension 722 may extend in a direction perpendicular to the second protrusion 7122, for example. The second extension 722 may extend along the axis of the supporting member 110, or inclined at a predetermined angle from the axis of the supporting member 110.

For example, the first extension 721 and the second extension 722 may extend substantially parallel to each other, but are not limited thereto. The extension 720 may tightly contact the side portion of the hanger bar 10 in the locked state. As the extension 720 tightly contacts the side portion of the hanger bar 10, the lateral movement of the hanger bar 10 generated by vibration or the like may be fixed.

According to an embodiment, the clip member 700 may include an engaging portion 730 extending from an end portion of each extension 720. The engaging portion 730 may be selectively locked to the upper surface of the hanger bar 10 according to the rotation of the clip member 700. The engaging portion 730 may extend in a direction perpendicular to the extension 720.

According to an embodiment, the engaging portion 730 may include a first engaging portion 731 extending from the first extension 721 in a first direction. According to an embodiment, the engaging portion 730 may include a second engaging portion 732 extending from the second extension 722 in a second direction. The first direction and the second direction may be opposite and parallel to each other. At least one of the first engaging portion 731 or the second engaging portion 732 may have a straight-line cross section.

Here, the first rotation direction may refer to a direction in which the clip member 700 rotates about the supporting member 110. For example, when the clip member 700 is rotated in the first rotation direction, the clip member 700 may be locked to the hanger bar 10. For example, when the clip member 700 is rotated in the second rotation direction opposite to the first rotation direction, the clip member 130 may be in an unlocked state.

According to an example, the lower edge of the engaging portion 730 may be inclined or rounded. When the clip member 700 is switched from the unlocked state to the locked state, the lower edge of the engaging portion 730 may be inclined or rounded so that the engaging portion 730 is easily locked to the upper surface of the hanger bar 10.

According to an example, when the clip member 700 is viewed from the top, the engaging portion 730 may protrude so that the free end does not overlap the body 710. For example, when the clip member 700 is viewed from the top, the engaging portion 730 may be formed to extend in the tangential direction from the edge of the body 710.

According to an example, the clip member 700 may be configured to be selectively locked to or unlocked from the hanger bar 10 by rotating about the supporting member 110 as an axis. For example, the body 710 of the clip member 700 supports one surface (e.g., the lower surface) of the hanger bar 10, and the engaging portion 730 of the clip member 700 is tightly locked to the other surface (e.g., the upper surface) of the hanger bar 10, thereby fixing the movement of the hanger bar 10. For example, the body 710 of the clip member 700 may support a lower portion of the hanger bar 10. For example, the engaging portion 730 of the clip member 700 tightly contacts the upper surface of the upper portion of the hanger bar 10 to prevent the hanger bar 10 from ascending due to vibration. The clip member 700 may be fixed so as not to be separated from the hanger bar 10 in the locked state. The clip member 700 may be coupled to or separated from the hanger bar 10 in the unlocked state. The clip member 700 may fix the movement of the first fastening member 120 and the hanger bar 10 above the first fastening member 120. When vibration occurs in the hanger bar 10 due to the operation of the indoor unit (e.g., the indoor unit 1 of FIG. 1), the hanger bar 10 may be moved from the upper side of the first fastening member 120 so that the height of the indoor unit 1 may deviate off. The clip member 700 may be disposed to stop the upward movement of the first fastening member 120 so that the hanger bar 10 may be fixed on the first fastening member 120. The clip member 700 may be formed of steel or stainless steel, but is not limited thereto.

According to an example, the clip member 700 may include an accommodation space 740 defined to accommodate at least portion of the first fastening member 120. For example, the body 710 may include an accommodation space 740 defined to accommodate at least portion of the first fastening member 120. If the clip member 700 is assembled to the lower side of the first fastening member 120, the clip member 700 may fix not only the hanger bar 10 but also the movement of the first fastening member 120 in the locked state.

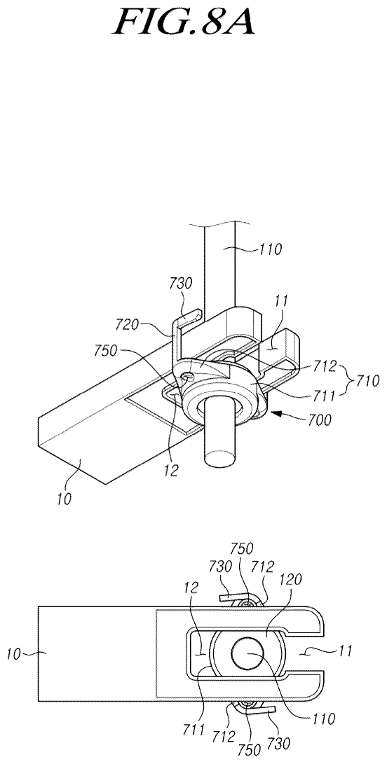

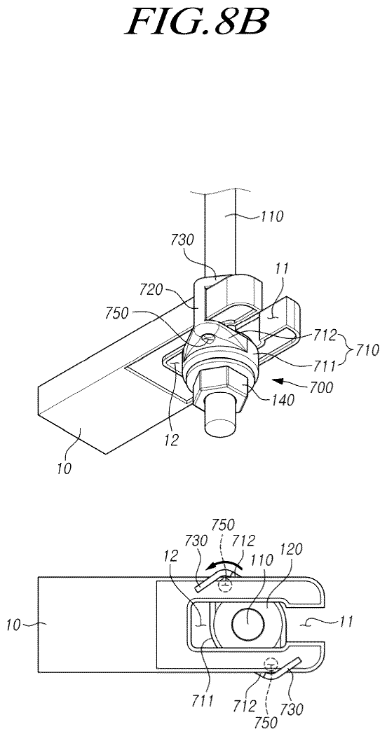

FIGS. 8A and 8B are views illustrating an assembly process of an installation structure including the clip member of FIG. 7 according to one or more embodiments.

The components shown in the assembly process of FIGS. 8A and 8B may be substantially identical to the components of the installation structure 100 described in FIG. 7.

FIG. 8A illustrates a process of assembling the first fastening member 120 after being fastened to the lower side of the hanger bar 10, as illustrated in FIG. 5A.

Referring to FIG. 8A, the clip member 700 may be coupled to the supporting member 110 from a lower end portion of the supporting member 110. The through hole 711a of the body 710 may pass through the supporting member 110 so that the body 710 of the clip member 700 is positioned under the first fastening member 120. After the operator completes the height adjustment of the indoor unit 1 using the first fastening member 120, the clip member 700 may be inserted into the supporting member 110. The clip member 700 may be inserted until the engaging portion 730 is positioned close to the upper surface of the hanger bar 10. In this case, the clip member 700 may be inserted in the unlocked state. In the unlocked state, the clip member 700 may be assembled to the hanger bar 10 or separated from the hanger bar 10.

Referring to FIG. 8B, in a state in which the engaging portion 730 of the clip member 700 is positioned close to the upper surface of the hanger bar 10, the clip member 700 may be rotated in the first rotation direction to be switched into the locked state. The operator may rotate the clip member 700 directly by hand, or may rotate the clip member 700 after inserting and fixing a tool into the opening 750 of the clip member 700 and then rotating the tool. The clip member 700 may fix the vertical movement of the hanger bar 10 as the engaging portion 730 is locked to the upper surface of the hanger bar 10.

After rotating the clip member 700 to be in the locked state, the second fastening member 140 may be coupled to the supporting member 110 from the lower end portion of the supporting member 110. The second fastening member 140 may be inserted into the supporting member 110 to be positioned below the body 710 of the clip member 700. The second fastening member 140 may fix the clip member 700 so as not to rotate by tightening the lower portion of the clip member 700. The second fastening member 140 may prevent the clip member 700 from being rotated and unlocked due to vibration generated as the indoor unit 1 operates, or as the use period is prolonged.

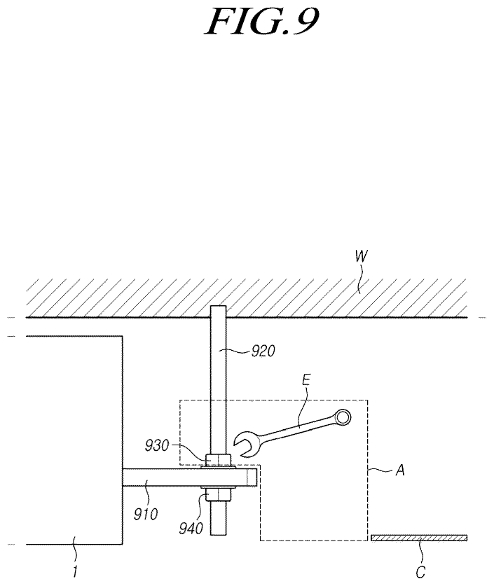

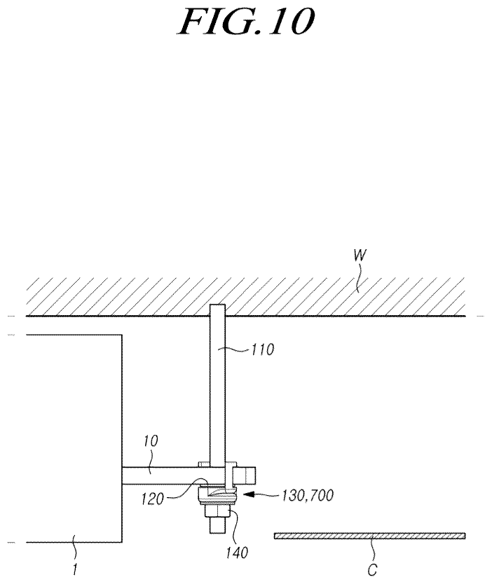

FIG. 9 is a view illustrating a working space required to install an indoor unit of an air conditioner using a related art installation structure. FIG. 10 is a view illustrating a working space required to install an indoor unit on a ceiling using an installation structure according to an embodiment.

Referring to FIG. 9, a related art installation structure may include a full-threaded bolt 920, an upper nut 930, and a lower nut 940. The operator may insert the full-threaded bolt 920 into the hanger bar 910 in a state in which the upper nut 930 is fastened to the full-threaded bolt 920 at an appropriate position. Thereafter, the operator may install the indoor unit 1 on the ceiling by adjusting the height of the hanger bar 910 using the lower nut 940, and then tightening the upper nut 930 to fix the movement of the hanger bar 910. In this case, the operator should access the upper nut 930 using a tool such as a spanner E to tighten the upper nut 930, and an additional working space A is required to access and tighten the upper nut 930. In order to provide such an additional working space A, it is required to further remove the ceiling surface at the corresponding position, which causes inconvenience. Further, when the ceiling-mounted indoor unit 1 is installed in a space with a limited area, it may be difficult to secure a working space for tightening the upper nut 930.

Referring to FIG. 10, when the installation structure 100 according to an embodiment is used, it is possible to install the ceiling-mounted indoor unit 1 by adjusting the height of the hanger bar 10 using the first fastening member 120, fixing the vertical movement of the hanger bar 10 using the clip member 130 or 700, and then fixing the clip member 130 or 700 using the second fastening member 140. In this case, since the first fastening member 120, the clip member 130 or 700, and the second fastening member 140 are all positioned under the hanger bar 10, unlike when the related art installation structures 920, 930, and 940 are used, the indoor unit 1 may be installed even without an additional working space (e.g., the additional working space A of FIG. 9). Further, if the indoor unit 1 is installed using the installation structure 100 of the disclosure, the additional working space A may be omitted, so the indoor unit 1 may be installed by removing the ceiling surface C to a minimum.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” “comprise” and variations thereof are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An installation structure for a ceiling-mounted indoor unit, the installation structure comprising:
a supporting member comprising an end portion fixed to a ceiling wall and configured to pass through a hanger bar connected to the indoor unit; and
a clip member comprising:
a body comprising a penetration portion in which the supporting member is configured to pass through,
an extension extending along a length of the supporting member from the body, and
an engaging portion extending from an end portion of the extension and configured to be locked to the hanger bar.

2. The installation structure of claim 1, wherein the clip member is configured to be rotated about the supporting member to be selectively locked to and unlocked from the hanger bar.

3. The installation structure of claim 1, wherein the body further comprises a protrusion protruding horizontally outward from the penetration portion.

4. The installation structure of claim 3, wherein the extension extends from an edge of the protrusion along an outside of a side surface that connects a lower surface and an upper surface of the hanger bar.

5. The installation structure of claim 3, wherein the protrusion comprises an opening.

6. The installation structure of claim 3, wherein the protrusion comprises a first protrusion and a second protrusion protruding symmetrically from opposite sides of the penetration portion,
wherein the extension comprises a first extension extending from an edge of the first protrusion in a direction perpendicular to the first protrusion, and a second extension extending from an edge of the second protrusion in a direction perpendicular to the second protrusion, and
wherein the engaging portion comprises a first engaging portion extending in a direction perpendicular to the first extension, and a second engaging portion extending in a direction perpendicular to the second extension.

7. The installation structure of claim 6, wherein the first engaging portion extends from an end portion of the first extension in a first direction, and the second engaging portion extends from an end portion of the second extension in a second direction that is parallel to and opposite of the first direction along a rotation direction.

8. The installation structure of claim 1, wherein the body is configured to support a lower surface of the hanger bar, and
wherein the engaging portion extends along a plane parallel to an upper surface of the hanger bar and is configured to engage with the upper surface of the hanger bar.

9. The installation structure of claim 1, further comprising:
a first fastening member fastened to a lower side of the hanger bar and configured to support the hanger bar; and
a second fastening member fastened to a lower side of the clip member and configured to support the clip member,
wherein the body of the clip member is between the first fastening member and the second fastening member, and
wherein the body further comprises an accommodation space configured to accommodate at least a portion of the first fastening member.

10. A clip member for fixing a hanger bar supporting a ceiling-mounted indoor unit, the clip member comprising:
a body comprising a penetration portion having a through hole;
an extension extending from the body in a direction perpendicular to the body; and
an engaging portion extending from an end portion of the extension and configured to lock to the hanger bar.

11. The clip member of claim 10, wherein the engaging portion extends in a direction perpendicular to the extension.

12. The clip member of claim 10, wherein the body is configured to support a lower portion of the hanger bar, and the engaging portion is configured to engage with an upper surface of the hanger bar.

13. The clip member of claim 10, wherein the engaging portion is configured to be selectively locked to and unlocked from the hanger bar by rotation about the through hole.

14. The clip member of claim 10, wherein a lower edge of the engaging portion is inclined or rounded.

15. The clip member of claim 10, wherein the extension comprises a first extension, and a second extension symmetrical to the first extension with respect to the through hole,
wherein the engaging portion comprises a first engaging portion extending in a direction perpendicular to the first extension, and a second engaging portion extending in a direction perpendicular to the second extension, and
wherein the first engaging portion and the second engaging portion extend from respective end portions of the first extension and the second extension along a rotation direction.
